(19) United States
(12) Patent Application Publication
(10) Pub. No.: US 2016/0370779 A1
(43) Pub. Date: Dec. 22, 2016

(54) METHOD AND APPARATUS FOR DETERMINING DISPLACEMENT OF A REMOTE TERMINAL UNIT

(71) Applicant: Honeywell International Inc., Morristown, NJ (US)

(72) Inventors: Zhen Wang, Shanghai (CN); Guokun Song, Shanghai (CN); Rui Zhang, Shanghai (CN); Meng Hu, Shanghai (CN); Wei Wang, Shanghai (CN); Congcong Huo, Shanghai (CN); Yurong Chen, Shanghai (CN)

(21) Appl. No.: 14/742,516

(22) Filed: Jun. 17, 2015

(51) Int. Cl. G05B 19/042

(52) U.S. Cl. CPC G05B 19/0423; G05B 2219/25201

(57) ABSTRACT

A system includes a control system and a Remote Terminal Unit (RTU). The control system is configured to communicate data with one or more field devices via the RTU. The RTU includes a motor configured to vibrate the RTU unit. The RTU also includes an acceleration sensor configured to measure an acceleration of the RTU. The RTU also includes an I/O module configured to transmit a displacement computing by the acceleration of the RTU.

### TECHNICAL FIELD

This disclosure is generally directed to industrial process control and automation systems. More specifically, this disclosure is directed to an apparatus and method for detecting the status and displacement of a remote terminal unit (RTU).

### BACKGROUND

An RTU represents a device or system that provides localized control and data access at a site that is remote from a supervisory control and data acquisition (SCADA) system or other automation system. For example, multiple RTUs can be used at different sites and for different purposes in an oil and gas field. The RTUs can collect data, perform local control, record historical values using sensors and actuators at different sites (such as wells, pipelines, and compression stations), and provide live and historical data to an automation system. The automation system can execute control logic and alter the operations of actuators at the different sites via the RTUs. The RTUs themselves could also incorporate algorithms for data analytics.

In general, RTUs have increased in usage and complexity from their early designs in the 1970s. Today, RTUs often need to reliably support a large set of application-specific network capabilities and protocols, as well as support a number of control execution models and provide smart device integration.

### SUMMARY

This disclosure provides an apparatus and method for detecting the status and displacement of a remote terminal unit (RTU).

In a first embodiment, a system is provided. The system includes a control system and a Remote Terminal Unit (RTU). The control system is configured to communicate data with one or more field devices via the RTU. The RTU includes a motor configured to vibrate the RTU unit. The RTU also includes an acceleration sensor configured to measure an acceleration of the RTU. The RTU also includes an Input/Output (I/O) module configured to transmit a displacement, which is computed based on the acceleration, of the RTU.

In a second embodiment, a Remote Terminal Unit (RTU) is provided. The RTU includes a motor configured to vibrate the RTU unit. The RTU also includes an acceleration sensor configured to measure an acceleration of the RTU. The RTU also includes an I/O module configured to transmit a displacement, which is computed based on the acceleration, of the RTU.

In a third embodiment, a method is provided. The method includes vibrating a remote terminal unit (RTU) using a motor. The method also includes measuring an acceleration of the RTU with an acceleration sensor. The method also includes computing a displacement based on the acceleration. The method also includes transmitting the displacement of the RTU using an Input/Output (I/O) module.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example industrial control and automation system having a remote terminal unit (RTU) according to this disclosure;

FIG. 2 through 4B illustrate details of example RTUs according to this disclosure; and

FIGS. 5 and 6 illustrate example methods according to this disclosure.

### DETAILED DESCRIPTION

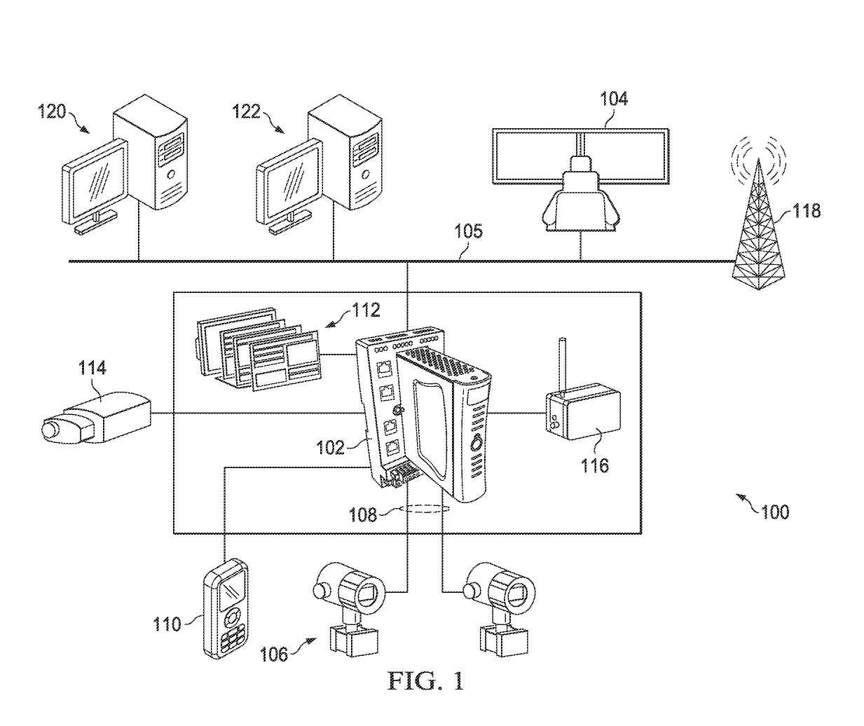

FIGS. 1 through 6, discussed below, and the various examples used to describe the principles of the present invention in this patent document are by way of illustration only and should not be construed in any way to limit the scope of the invention. Those skilled in the art will understand that the principles of the present invention may be implemented in any suitable manner and in any type of suitably arranged device or system.

As noted above, remote terminal units (RTUs) have increased in complexity from their early designs, and current RTUs often need to reliably support a number of more advanced features. Current RTUs cannot detect the displacement of the RTU while in service, which is especially an issue in place without workers present, such as deserts, forests, and oil or gas wells. Furthermore, no present system exists for an RTU to detect the mechanical installation of the components installed in the RTU. An RTU displaced or dropped during operation can cause the temperature inside of the RTU to increase, which can affect different operations of the RTU and can affect the signal quality of the wires connecting the components of the RTU.

FIG. 1 illustrates an example industrial control and automation system 100 having an RTU 102 according to this disclosure. Note that the RTU 102 may also be referred to in the art as a remote telemetry unit. Also note that while a single RTU 102 is shown here, the system 100 could include any number of RTUs 102 distributed in one or more geographical areas.

The RTU 102 represents a device or system that provides localized control and data access at a site that is remote from a supervisory control and data acquisition (SCADA) system or other control system 104. For example, the RTU 102 could be positioned at or near an oil, gas, or water well or power substation. In these or other situations, the RTU 102 can be used to collect data from local sensors and process the data to generate control signals for local actuators. The RTU 102 can also interact with the control system 104 as needed. In this way, process control and automation functions can be provided at locations remote from the control system 104. The control system 104 is shown as communicating with the RTU 102 over a wired network 105 and using wireless connections, such as via microwave, cellular, or other radio frequency (RF) communications. However, the RTU 102 could communicate with the control system 104 over any suitable wired or wireless connection(s). In some embodiments, the components 102-104 could ordinarily communicate using a wired connection, with wireless communications used as backup.

The RTU 102 also communicates and interacts with one or more industrial field devices 106. The field devices 106 could include sensors that measure one or more characteristics of a process, actuators that alter one or more characteristics of a process, or other industrial field devices. In this example, the RTU 102 uses wired connections 108 to communicate with the field devices 106. The wired connections 108 could include serial connections (such as RS232 or RS485 connections), Ethernet connections, industrial protocol connections, or other wired connections. Note, however, that the RTU 102 could also communicate wirelessly with one or more field devices 106.

The RTU 102 in this example also communicates and interacts with at least one local user device 110. The user device 110 could be used by personnel to interact with the RTU 102 or with the field devices 106 or the control system 104 communicating with the RTU 102. The user device 110 includes any suitable structure supporting user interaction with an RTU.

Various other components could optionally be used with the RTU 102. For example, the RTU 102 could interact with one or more human-machine interfaces (HMIs) 112, such as display screens or operator consoles. The HMIs 112 can be used to receive data from or provide data to the RTU 102. One or more security cameras 114 (such as Internet Protocol cameras) could be used to capture still or video images and to provide the images to a remote location (such as a security center) via the RTU 102. A wireless radio 116 could be used to support wireless communications between the RTU 102 and a remote access point 118, which communicates with the control system 104 or other remote systems via the network 105. The other remote systems can include a field device manager (FDM) 120 or other asset manager and/or an RTU builder 122. The FDM 120 can be used to configure and manage assets such as field devices (including the field devices 106), and the RTU builder 122 can be used to configure and manage RTUs (including the RTU 102).

The RTU 102 has the ability to support a flexible mix of input/output (I/O) channel types. For example, the channel types can include analog inputs (AIs), analog outputs (AOs), digital inputs (DIs), digital outputs (DOs), and pulse accumulator inputs (PIs). The AIs and AOs may or may not support digital communications, such as digital communications over 4-20 mA connections compliant with the HIGHWAY ADDRESSABLE REMOTE TRANSDUCER (HART) protocol. Some RTUs 102 can achieve a desired mix of I/O channel types using I/O cards that have a fixed number of inputs and outputs, where each input or output is fixed to a particular type. Other RTUs 102 can achieve a desired mix of I/O channel types using I/O cards with reconfigurable inputs or outputs. Moreover, some RTUs 102 can be expandable so that one or more I/O modules (each with one or more I/O channels) can be used with the RTUs 102.

In particular embodiments, the RTU 102 can have one, some, or all of the following features. First, the RTU 102 can include a motor for creating a vibration that causes small displacements in the RTU 102. Second, the RTU can include an acceleration sensor that detects movement of the RTU 102. The RTU 102 uses the signal from the acceleration sensor to determine whether the RTU 102 is displaced. The RTU 102 also uses the acceleration sensor to determine whether the installation is correct based on an acceptable amount of displacement caused by vibrations from the motor.

Although FIG. 1 illustrates one example of an industrial control and automation system 100 having an RTU 102, various changes may be made to FIG. 1. For example, the system 100 could include any number of each component. Also, the functional division shown in FIG. 1 is for illustration only. Various components in FIG. 1 could be combined, subdivided, or omitted and additional components could be added according to particular needs. Further, while shown as being used with wired field devices, the RTU 102 could be used with only wireless field devices or with both wired and wireless field devices. In addition, FIG. 1 illustrates one example operational environment where an RTU 102 can be used. One or more RTUs could be used in any other suitable system.

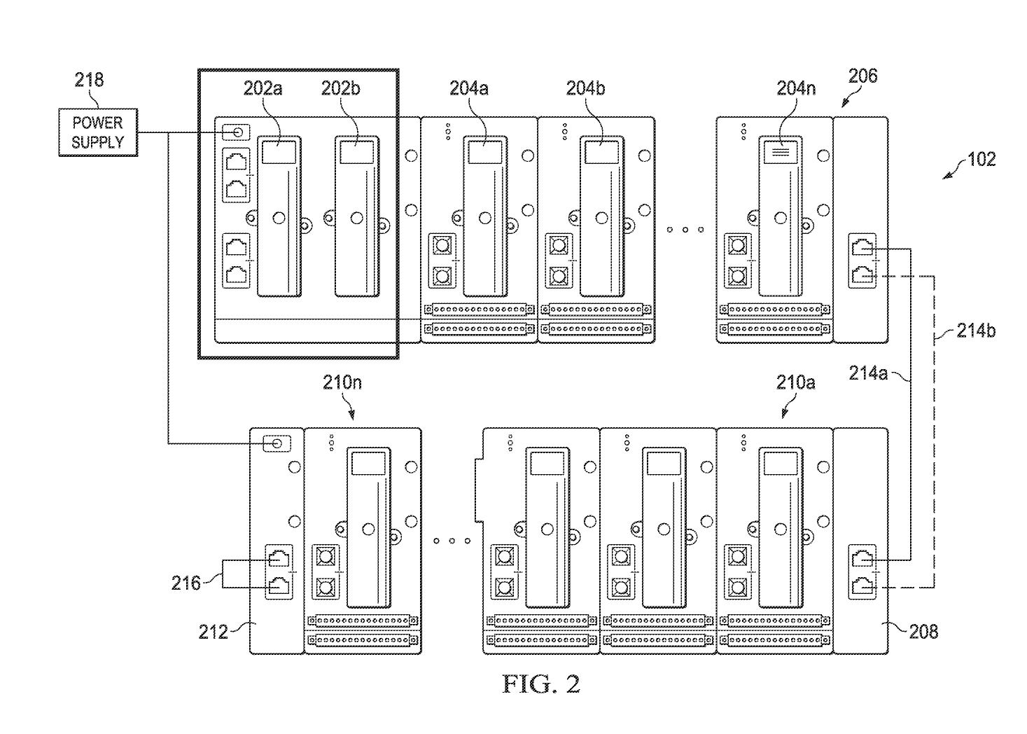

FIG. 2 illustrates details of an example RTU 102 according to this disclosure. For ease of explanation, the RTU 102 is described as being used in the system 100 of FIG. 1. However, the RTU 102 could be used in any other suitable system.

FIG. 2 illustrates an example of the RTU 102 with redundant controller modules 202a-202b, a first set of I/O modules 204a-204n, and an expansion board 206. Each controller module 202a-202b represents a module that executes control logic and other functions of the RTU 102. For example, each controller module 202a-202b could execute control logic that analyzes sensor data and generates control signals for actuators. Each controller module 202a-202b could also execute functions that control the overall operation of the RTU 102, such as functions supporting communications with external devices or systems. Each controller module 202a-202b includes any suitable structure for controlling one or more operations of an RTU. In some embodiments, each controller module 202a-202b includes at least one processing device that executes a LINUX or other operating system.

The I/O modules 204a-204n support communications between the controller modules 202a-202b and external devices or systems (such as the field devices 106) via I/O channels of the I/O modules 204a-204n. Each I/O module 204a-204n includes circuitry supporting the use of one or more I/O channels. If an I/O module supports the use of one or more reconfigurable I/O channels, the I/O module 204a-204n also includes circuitry that configures at least one I/O channel as needed. The circuitry can be used to configure and reconfigure each I/O channel as desired. For instance, example types of reconfigurable I/O channels are shown in U.S. Pat. No. 8,072,098; U.S. Pat. No. 8,392,626; and U.S. Pat. No. 8,656,065 (all of which are hereby incorporated by reference in their entirety). Also, the use of reconfigurable I/O channels in an RTU is described in U.S. patent application Ser. No. 14/228,142 (which is hereby incorporated by reference in its entirety). The RTU 102 can include any number of I/O modules 204a-204n. In some embodiments, a specified number of I/O modules 204a-204n (such as eight modules) can be built into the RTU 102.

The expansion board 206 allows the RTU 102 to be coupled to an expansion board 208, which is coupled to a second set of I/O modules 210a-210n. The I/O modules 210a-210n could have the same or similar structure as the I/O modules 204a-204n, and any number of I/O modules 210a-210n could be used in the second set (such as eight modules). An expansion board 212 can be used to couple to a third set of I/O modules. Additional I/O modules can be added in a similar manner.

Each expansion board 206, 208, 212 includes any suitable structure facilitating the addition of one or more I/O modules to an RTU. In this example, two electrical paths 214a-214b are formed through the RTU 102, and the electrical paths 214a-214b meet at a loop 216. The electrical paths 214a-214b could be formed in any suitable manner, such as by using Ethernet connections and electrical paths through the I/O modules and expansion boards. The loop 216 can be used to indicate that no additional I/O modules are presently connected to the RTU 102. Note, however, that the loop 216 could also be placed on the expansion board 206 to indicate that no additional sets of I/O modules are currently connected to the RTU 102.

A power supply (PS) 218 provides operating power to the components of the RTU 102. The power supply 218 includes any suitable structure(s) configured to provide operating power to an RTU. For example, the power supply 218 could include one or more batteries, solar panels, fuel cells, or other source(s) of power.

In some embodiments, the controller modules 202a-202b are implemented using separate circuit boards. Communications between the redundant controller modules 202a-202b could occur via various communication interfaces of the circuit boards. If the redundant controller modules 202a-202b are present in the RTU 102 (which need not always be the case), the RTU 102 can automatically manage which redundant controller module has control of each I/O module and provide seamless switchover upon a failure of a controller module.

Although FIG. 2 illustrates details of an example RTU 102, various changes may be made to FIG. 2. For example, the number(s) and type(s) of ports and interfaces shown in FIG. 2 are for illustration only. Also, the functional divisions of the RTU 102 shown in FIG. 2 are for illustration only. Various components in FIG. 2 could be omitted, combined, or further subdivided and additional components could be added according to particular needs.

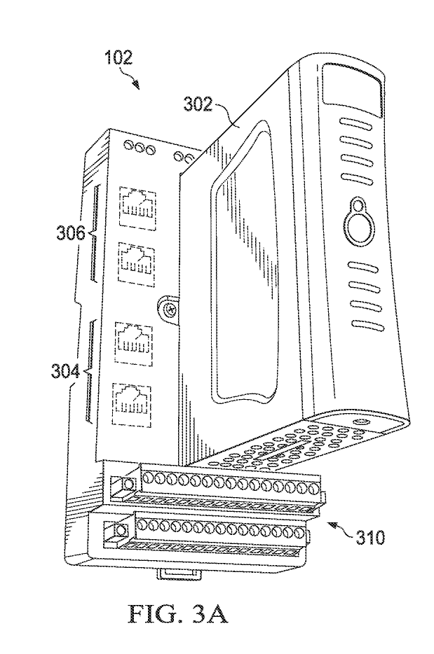

FIGS. 3A through 3C illustrate additional details regarding the example RTU 102. A housing 302 is used to encase and protect other components of the RTU 102. The housing 302 also provides access to various other components of the RTU 102, such as one or more ports or terminals. The housing 302 can have any suitable size, shape, and dimensions and be formed from any suitable material(s) (such as metal or ruggedized plastic).

The RTU 102 also includes two uplink/downlink ports 304, two RS232 ports 306, and two RS485 ports 308. The ports 304 can be used to couple the RTU 102 to higher-level or lower-level devices, such as the control system 104, FDM 120, or RTU builder 122 via the network 105. The ports 304 could represent any suitable structures for coupling to one or more communication links, such as Ethernet ports. The RS232 ports 306 and the RS485 ports 308 could be used to couple the RTU 102 to one or more field devices or other devices that use the RS232 or RS485 serial protocol.

Various I/O terminals 310 are also used to couple the RTU 102 to one or more field devices. The I/O terminals 310 here can be coupled to the I/O modules 204a-204n and thereby provide a communication path between the I/O modules 204a-204n and the field device(s) coupled to the I/O terminals 310. The I/O terminals 310 can be coupled to various types of field devices, and the I/O modules 204a-204n can be configured appropriately as AI (with or without digital communication), AO (with or without digital communication), DI, DO, and/or PI channels. The I/O terminals 310 include any suitable structures for coupling to different communication paths, such as screw terminals.

A power terminal 312 can be used to couple the RTU 102 to a power supply, such as the power supply 218. A slot 314 provides access to additional connectors, such as the expansion board 206 for coupling to the I/O modules 210a-210n.

A motor 322 is coupled to the RTU 102 and is operable to vibrate the RTU 102. In some embodiments, the motor 322 is a PCB-mounted vibration motor, which is a microelectromechanical motor, coupled to the surface of the second circuit board 318 of the RTU 102. For example, the motor 322 may be soldered onto the RTU 102. The RTU 102 can withstand an amount of vibration caused by operation of the motor 322. In certain embodiments, the motor is mounted on the backboard of the RTU 102.

An acceleration sensor 324 measures the acceleration along multiple axes, e.g., the X, Y, and Z axes of the RTU 102. The acceleration sensor 324 is coupled to the surface of the second circuit board 318. Measurements of the accelerations taken by the acceleration sensor 324 can be used to determine the displacement or orientation of the RTU 102.

During operation, a vibration of the RTU 102 caused by operation of the motor 322 results in a temporary displacement of the RTU 102 along one or more of the X, Y, and Z axes of the RTU 102. For example, the vibration of the RTU 102 may include a small movement back and forth (i.e., a temporary displacement) along the X axis of the RTU 102. This displacement can be determined based on measurements by one or more sensors, such as the acceleration sensor 324. When the displacement remains within an operational range, this indicates that the RTU 102 is installed correctly and operating accordingly. When the displacement exceeds the operational range, this indicates that the RTU 102 may have been installed incorrectly or dropped from the installed board.

Note that the numbers and types of ports and terminals shown in FIGS. 3A through 3C are for illustration only. The RTU 102 could include any suitable type(s) and number(s) of interfaces as needed or desired.

As shown in FIG. 3C, the RTU 102 further includes three printed circuit boards (PCBs). A first circuit board 316 represents the substrate on which the ports 304-308, I/O terminals 310, and other input/output components can be located. The circuit board 316 represents any suitable substrate, such as an Input Output Termination Assembly (IOTA) board. For this reason, the circuit board 316 may be referred to below as the IOTA board 316.

A second circuit board 318 and a third circuit board 320 are coupled to the IOTA circuit board 316. The second circuit board 318 represents a board having at least one processing device that executes an operating system for the RTU 102. For this reason, the circuit board 318 may be referred to below as the kernel board 318. The circuit board 318 could also include at least one memory, a power supply or power converter, and one or more communication interfaces. As a particular example, the circuit board 318 could include a field programmable gate array (FPGA).

The third circuit board 320 represents an application board that contains I/O modules, such as the I/O modules 204a-204n. The circuitry on the circuit board 320 can be used to reconfigure an I/O channel into an AI (with or without digital communication), AO (with or without digital communication), DI, DO, or PI channel. As a particular example, the circuit board 320 could include an application specific integrated circuit (ASIC) that includes the switches and other components used to provide reconfigurable I/O channels. For this reason, the circuit board 320 may be referred to below as the application board 320.

Although FIGS. 3A, 3B, and 3C illustrate details of an example RTU 102, various changes may be made to FIGS. 3A, 3B, and 3C. For example, the number(s) and type(s) of ports and interfaces shown in FIGS. 3A, 3B, and 3C are for illustration only. Also, the functional divisions of the RTU 102 shown in FIGS. 3A, 3B, and 3C are for illustration only. Various components in FIGS. 3A, 3B, and 3C could be omitted, combined, or further subdivided and additional components could be added according to particular needs.

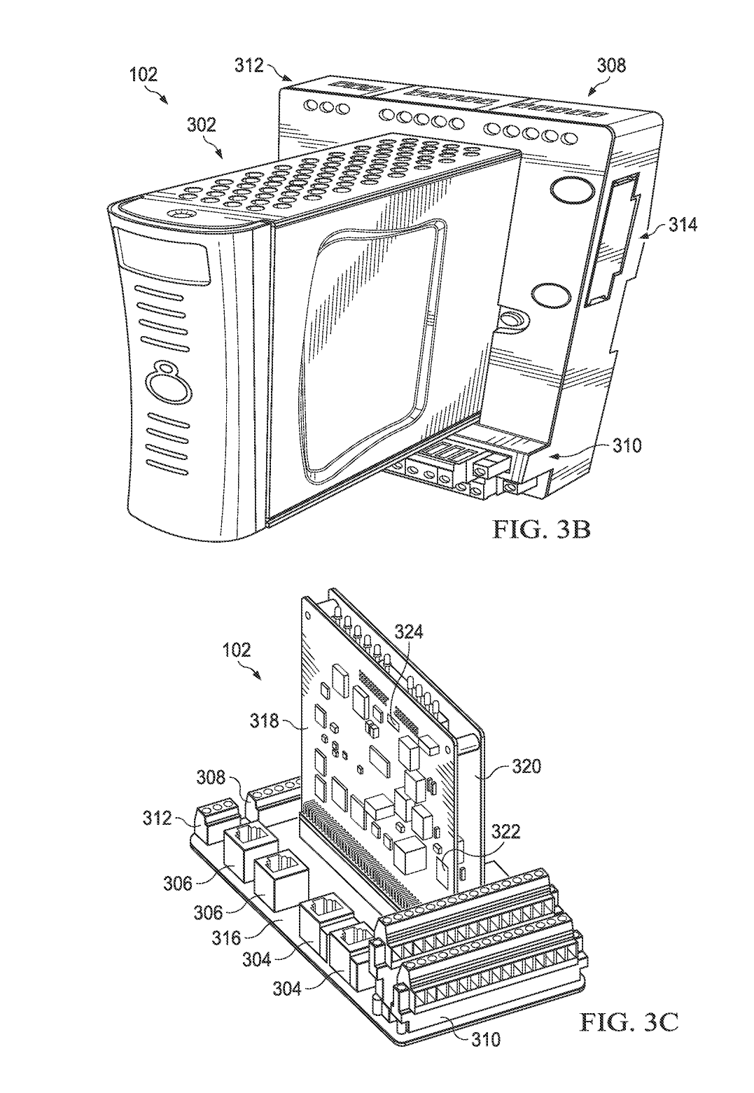

FIGS. 4A and 4B illustrate additional details regarding the example RTU 102. Note that the origin of the X, Y, and Z axes is indicated on the RTU 102 as an example of where the acceleration sensor 324 could be located in the RTU 102. The acceleration sensor 324 could be located anywhere inside the RTU 102.

As shown in FIG. 4A, the RTU 102 is in a correctly installed position. No displacement or movement is detected in the RTU 102. The X-direction 402 is indicated along what is referred to as the “width” of the RTU 102, the Y-direction 404 is indicated along the “height” of the RTU 102, and the Z-direction 406 is indicated along the “depth” of the RTU 102. These directions are for illustration only; other directions could be used to indicate the three dimensional space.

As shown in FIG. 4B, the RTU 102 is displaced from the position shown in FIG. 4A. The acceleration sensor 324 detects and measures the changes in the X-direction 402, the Y-direction 404, and the Z-direction 406. The measurements taken by the acceleration sensor 324 are used to calculate the overall displacement 408 of the RTU unit. The displacement 408 is transmitted to a remote system. The displacement 408 can be used for diagnostics of the RTU 102.

Although FIGS. 4A and 4B illustrate details of an example RTU 102, various changes may be made to FIGS. 4A and 4B. For example, the directions shown in FIGS. 4A and 4B are for illustration only. Various components in FIGS. 4A and 4B could be omitted, combined, or further subdivided and additional components could be added according to particular needs.

Control systems including SCADA communication systems can use DNP3 protocol. With DNP3 protocol, an RTU (such as RTU 102) receives event information (such as commands or requests for data) from a master system (such as control system 104, illustrated in FIG. 1). The RTU subsequently transmits the event information to field devices (such as field devices 106, illustrated in FIG. 1) using I/O modules. The RTU can also receive event information (such as field data or status information) from a field device and transmit the event information to the master system.

Event information includes point values (such as SCADA point values). For example, when an RTU receives event information from the master system, processing circuitry (such as a processing device on the second circuitry board 318) of the RTU stores the point values, for example with the event information, in a memory (or buffer) creating history backfill. The point values provide an indication or address of one or more field devices (or a master system) that are to receive particular event information from the RTU. The point values can be temporarily stored in the memory until the memory is full, for example, when transmitting event information to a field device and communication between the SCADA communication system and the RTU is lost. The processing circuitry of the RTU can also stop saving point values in the memory or overwrite the oldest point values depending on the configuration of the processing circuitry or the RTU.

It should be understood that DNP3 protocol supports unsolicited responses. For example, once an RTU receives event information from a field device, the RTU can transmit the event information to the master system without receiving a request from the master system to receive the event information.

The RTU also calculates one or more select durations of time that event information and point values can be stored or backfilled in the memory before I/O modules power on to transmit event information. In an embodiment, the select durations of time that event information and point values can be stored or backfilled in the memory before I/O modules are powered on to transmit event information can be calculated based on a current network speed measured, for example, by the RTU.

It should be understood that the RTU will automatically transmit event information when the memory storing the point values and event information is full so that no data history is loss. It should also be understood that the RTU will automatically transmit event information when a system alarm or a system error (such as due to a loss in communication or a reduction in communication speed) is activated.

The RTU automatically calculates how long data (such as event information and point values) can be backfilled in the memory or how much data will be backfilled in the memory. The duration of time that data can be backfilled in the memory or the amount of data that can be backfilled in the memory can be based on user defined configurations or system constraints. The calculated time can serve as a basis to determine the cycle parameters to physical power off the I/O modules.

The concepts described herein are directed to detecting the displacement of the RTU installed, especially in remote locations where access or monitoring is difficult.

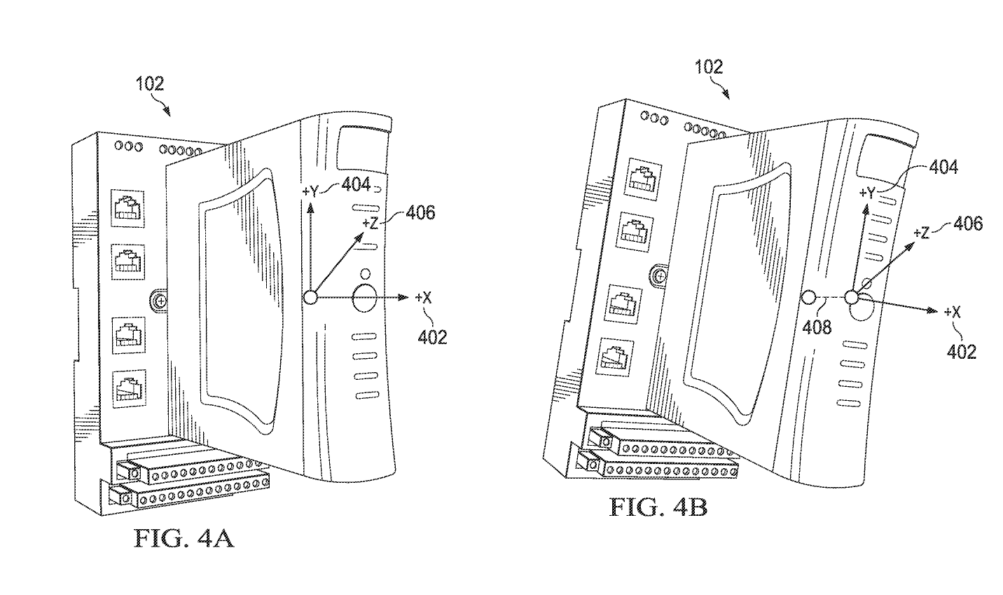

FIG. 5 illustrates an example method 500 for detecting the displacement of the RTU according to this disclosure. For ease of explanation, the method 500 is described with respect to the RTUs 102 and control system 104 shown in FIGS. 1 through 4B. However, the method 500 could be used by any suitable RTU and in any suitable system.

The method 500 includes at block 505 detecting and measuring an acceleration of the RTU using an acceleration sensor. The acceleration is measured in the X-direction, the Y-direction, and the Z-direction.

As shown at block 510, the RTU calculates the displacement of the RTU using the measurements from the acceleration sensor. At block 515, the RTU transmits the displacement of the RTU to a remote system. The displacement indicates movement of the RTU, and the operator receiving the displacement determines whether the displacement is a concern for the continued operation of the RTU. In some cases, the RTU may need to be reinstalled.

Although FIG. 5 illustrates one example of a method 500 for detecting the displacement of RTU I/O modules, various changes may be made to FIG. 5. For example, while shown as a series of steps, various steps shown in FIG. 5 could overlap, occur in parallel, or occur multiple times. Moreover, some steps could be combined or removed and additional steps could be added.

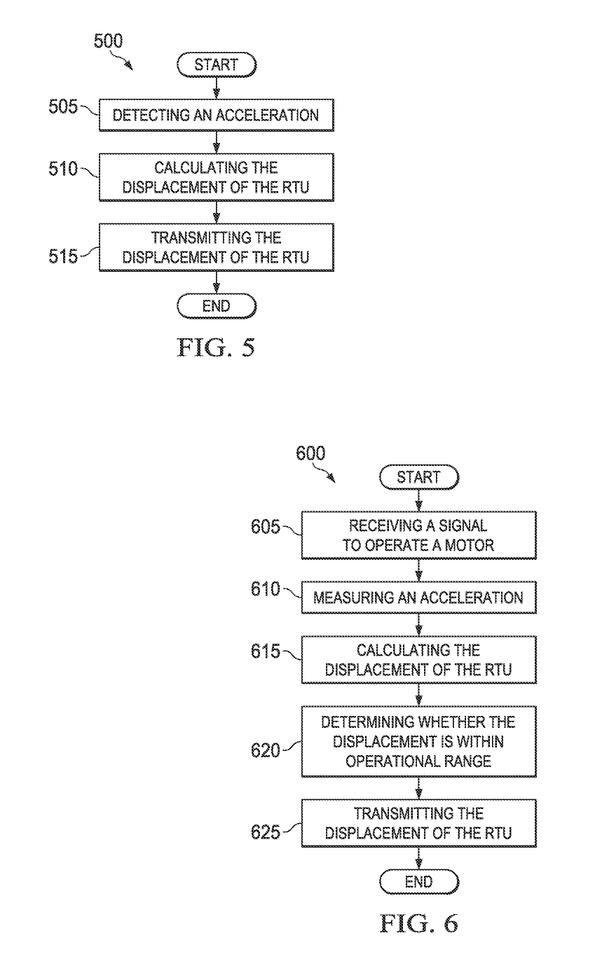

FIG. 6 illustrates an example method 600 for operating the motor to generate the vibration and detecting the displacement of RTU I/O modules according to this disclosure. For ease of explanation, the method 600 is described with respect to the RTUs 102 and control system 104 shown in FIGS. 1 through 4B. However, the method 600 could be used by any suitable RTU and in any suitable system.

The method 600 includes at block 605 receiving a signal to operate a motor mounted to the RTU. Operating the motor can cause a vibration of the RTU. Vibrating the RTU allows analysis of the RTU from a remote location in order to determine correct installation or maintenance of the RTU based on an operational range of acceptable displacement. At block 610, an acceleration sensor coupled to the RTU measures the acceleration of the RTU in the X-direction, the Y-direction, and the Z-direction.

At block 615, the RTU calculates the displacement of the RTU using the measurements from the acceleration sensor. At block 620, the RTU determines whether the displacement is within the operational range. The RTU can receive subsequent event information with another point value and also store the subsequent event information. At block 625, the RTU transmits the displacement of the RTU to a remote system. The displacement signals movement of the RTU, and the operator receiving the displacement determines whether the displacement is a concern for the continued operation of the RTU and the RTU needs to be reinstalled.

Although FIG. 6 illustrates one example of a method 600 for operating the motor to generate vibration and detecting status and displacement of an RTU, various changes may be made to FIG. 6. For example, while shown as a series of steps, various steps shown in FIG. 6 could overlap, occur in parallel, or occur multiple times. Moreover, some steps could be combined or removed and additional steps could be added.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a control system configured to communicate data with one or more field devices via a remote terminal unit (RTU); and
the RTU comprising:
a motor configured to vibrate the RTU; and
an acceleration sensor configured to measure an acceleration of the RTU; and
an Input/Output (I/O) module configured to transmit a displacement, wherein the displacement is computed based on the acceleration of the RTU.

2. The system of claim 1, wherein the acceleration is measured in an X-direction, a Y-direction, and a Z-direction.

3. The system of claim 1, wherein the RTU is configured to compute a displacement of the RTU.

4. The system of claim 3, wherein the RTU is further configured to determine whether the displacement is within an operational range.

5. The system of claim 3, wherein the I/O module is further configured to transmit an error message when the displacement is outside of an operational range.

6. The system of claim 1, wherein the I/O module is further configured to receive a signal to operate the motor to vibrate.

7. The system of claim 1, wherein the motor is mounted on a backboard of the RTU.

8. A Remote Terminal Unit (RTU) comprising:
a motor configured to vibrate the RTU;
an acceleration sensor configured to measure an acceleration of the RTU; and
an Input/Output (I/O) module configured to transmit a displacement, wherein the displacement is computed based on the acceleration of the RTU.

9. The RTU of claim 8, wherein the acceleration is measured in an X-direction, a Y-direction, and a Z-direction.

10. The RTU of claim 8, wherein the RTU is configured to compute a displacement of the RTU.

11. The RTU of claim 10, wherein the RTU is further configured to determine whether the displacement is within an operational range.

12. The RTU of claim 10, wherein the I/O module is further configured to transmit an error message when the displacement is outside of an operational range.

13. The RTU of claim 8, wherein the I/O module is further configured to receive a signal to operate the motor to vibrate.

14. The RTU of claim 8, wherein the motor is mounted on a backboard of the RTU.

15. A method comprising:
vibrating a remote terminal unit (RTU) using a motor;
measuring an acceleration of the RTU using an acceleration sensor;
computing a displacement based on the acceleration; and
transmitting the displacement of the RTU using an Input/Output (I/O) module.

16. The method of claim 15, wherein measuring the acceleration of the RTU comprises measuring the acceleration in an X-direction, a Y-direction, and a Z-direction.

17. The method of claim 15, further comprising computing a displacement of the RTU.

18. The method of claim 17, further comprising determining whether the displacement is within an operational range.

19. The method of claim 17, further comprising transmitting an error message when the displacement is outside of an operational range.

20. The method of claim 15, further comprising receiving a signal to operate the motor to vibrate.
